(19) United States
(12) Patent Application Publication
(10) Pub. No.: US 2026/0210327 A1
(43) Pub. Date: Jul. 23, 2026

(54) WIND TURBINE BLADE COMPRISING A TRAILING EDGE SECTION HAVING A PLURALITY OF SLITS WITH VARYING LENGTHS

(71) Applicant: LM WIND POWER A/S, Kolding (DK)

(72) Inventor: Guannan WANG, Schenectady, NY (US)

(21) Appl. No.: 19/138,413

(22) PCT Filed: Dec. 11, 2023
(86) PCT No.: PCT/EP2023/085083

§ 371 Date: Jun. 12, 2025

(30) Foreign Application Priority Data
Dec. 16, 2022 (EP) 22214216.8

(51) Int. Cl. F03D 1/06

(52) U.S. Cl. CPC F03D 1/06495; F03D 1/0645; F05B 2240/3042; F05B 2260/96

(57) ABSTRACT

The present invention relates to a wind turbine blade having a profiled contour including a pressure side and a suction side and a leading edge and a trailing edge with a chord having a chord length extending therebetween, the wind turbine blade extending in a spanwise direction between a root end and a tip end, wherein the wind turbine blade comprises a trailing edge section defined between a first trailing edge section end and a second trailing edge section end, wherein the trailing edge section comprises a plurality of slits, including: a first plurality of slits extending a first distance from the first trailing edge section end toward the second trailing edge section end, and a second plurality of slits extending a second distance from the first trailing edge section end toward the second trailing edge section end, wherein the second distance is smaller than the first distance, and

wherein the trailing edge section is part of the wind turbine blade or wherein the trailing edge section is part of a trailing edge panel attached to the wind turbine blade.

### FIELD OF INVENTION

The present invention relates to a wind turbine blade comprising a trailing edge section comprising a plurality of slits with varying lengths and to a trailing edge panel configured to be attached to a wind turbine blade, wherein the trailing edge panel comprises a trailing edge section comprising a plurality of slits with varying lengths.

### BACKGROUND OF THE INVENTION

Wind power is increasingly popular due to its clean and environmentally friendly production of energy. The rotor blades of modern wind turbines capture kinetic wind energy by using sophisticated blade design created to maximise efficiency.

One of the continued considerations for wind turbine blade design is the operational noise produced when such blades rotate, in particular for onshore wind turbine installations. A large portion of the noise produced during wind turbine operation is due to turbulence formed at the trailing edge of a wind turbine blade as the relatively faster suction side airflow meets the relatively slower pressure side airflow. The relatively high level of turbulent kinetic energy in the combined airflows results in a scattering of pressure fluctuations resulting from turbulent airflow at the trailing edge, which produces scattering noise.

As modern wind turbine blades are manufactured at increasingly longer blade lengths, the longer span of the blades may result in higher relative wind speeds experienced by the blades. Accordingly, this can lead to relatively large levels of trailing edge noise. Also, the size of the noise source increases, leading to higher noise levels, when not taking countermeasures. Hence, noise-reducing devices and associated blade designs are increasingly desired.

To this end, modern wind turbine blades are sometimes provided with serrations along the blade trailing edges, in an effort to reduce blade trailing edge noise and/or to improve wind turbine blade efficiency, as can be seen in EP1314885. The serrations may be provided by attaching a serrated panel at the trailing edge of the wind turbine blade. While the noise-mitigating properties of such serrations are advantageous, there is still a need to optimise the design of noise-reducing devices to maximise noise mitigation.

Hence, an optimized wind turbine blade or trailing edge panel for a wind turbine blade with improved noise reduction would be advantageous.

### SUMMARY OF INVENTION

Thus, an object of the present invention is to provide an optimized wind turbine blade or trailing edge panel for a wind turbine blade with improved noise reduction. The present inventors have found that said object may be achieved in a first aspect of the invention relating to a wind turbine blade comprising a shell structure having a profiled contour including a pressure side and a suction side and a leading edge and a trailing edge with a chord having a chord length extending therebetween, the shell structure of the wind turbine blade extending in a spanwise direction between a root end and a tip end, wherein the wind turbine blade comprises a trailing edge section defined between a first trailing edge section end and a second trailing edge section end, wherein the trailing edge section comprises a plurality of slits, including:
a first plurality of slits extending a first distance from the first trailing edge section end toward the second trailing edge section end, and
a second plurality of slits extending a second distance from the first trailing edge section end toward the second trailing edge section end, wherein the second distance is smaller than the first distance, and
   wherein the trailing edge section is part of the shell structure of the wind turbine blade or wherein the trailing edge section is part of a trailing edge panel attached to the shell structure of the wind turbine blade.

The present inventors have found that a wind turbine blade comprising a trailing edge section according to the present invention effectively reduces noise and even may perform better than wind turbine blades with serrated trailing edges.

In preferred embodiments, the first trailing edge section end is defined at an outermost edge of the wind turbine blade most distal to the leading edge of the wind turbine blade and the second trailing edge section end is defined between the first trailing edge section end and the leading edge of the wind turbine blade. In preferred embodiments, the first trailing edge section end corresponds to the trailing edge of the wind turbine blade.

In some embodiments, the trailing edge section is part of the shell structure of the wind turbine blade and the first trailing edge section end corresponds to the trailing edge of the shell structure of the wind turbine blade and the second trailing edge section end extends along at least part of the span of the shell structure of the wind turbine blade and is a plane going through the shell structure of the wind turbine blade defined at a predetermined distance from the first trailing edge section end toward the leading edge of the shell structure of the wind turbine blade. In other words, the slits may be formed in a main part of the wind turbine blade itself. It is understood that the shell structure may comprise a pre-manufactured trailing edge part that may form part of the aerodynamic shell, e.g. a substantially wedge-shaped trailing edge part integrated in the blade shell structure.

In other embodiments, the trailing edge section is part of a trailing edge panel attached to the shell structure of the wind turbine blade, wherein the trailing edge panel comprises:
an attachment section being attached to and extending from the trailing edge of the shell structure of the wind turbine blade and to an upstream position on a first blade side of the shell structure of the wind turbine blade,
a trailing edge section extending from the attachment section and projecting out from the trailing edge of the shell structure of the wind turbine blade, wherein
   the first trailing edge section end extends along at least part of the span of the shell structure of the wind turbine blade and is the most distal end of the trailing edge section relative to the attachment section, and
   the second trailing edge section end extends along at least part of the span of the shell structure of the wind turbine blade and is a plane going through the trailing edge panel defined at a predetermined distance from the first trailing edge section end toward the attachment section.

In other words, the slits are formed in an add-on that is attached to the blade surface.

The first blade side of the shell structure of the wind turbine blade is the pressure side or the suction side.

In both of the above embodiments, the first trailing edge section end is always an outermost part of the wind turbine blade at the trailing edge, whether or not the trailing edge panel is attached to a main blade or integrally formed with the main blade. The first trailing edge section end is in the form of a surface at the outermost part of the wind turbine blade at the trailing edge. In case the trailing edge section is part of the shell structure of the wind turbine blade, the first trailing edge section end is the trailing edge of the shell structure. In case a trailing edge panel is attached to the wind turbine blade, the part of the trailing edge panel most distal to the trailing edge of the shell structure of the wind turbine blade is considered the first trailing edge section end. Thus, the two alternative embodiments according to the first aspect of the invention are actually the same, except from the fact that in one embodiment, the plurality of slits of the trailing edge section are arranged in the wind turbine blade shell structure and in other embodiments, the plurality of slits are arranged in an add-on trailing edge section attached to trailing edge of the shell structure of the wind turbine blade.

Furthermore, for both of the above embodiments, the second trailing edge section end is not an axis or surface as such but defined as a virtual plane going through the shell structure of the wind turbine blade or a plane going through the trailing edge panel a predetermined distance from the first trailing edge section.

The second trailing edge section end of the trailing edge panel is preferably arranged below the trailing edge of the shell structure of the wind turbine blade, such that the second trailing edge section end is defined by a plane extending from the trailing edge of the shell structure of the wind turbine blade and through the trailing edge panel, which is attached to the trailing edge of the shell structure of the wind turbine blade.

The trailing edge section is defined between the first trailing edge section end and the second trailing edge section end. Preferably, the first trailing edge section end is parallel or substantially parallel to the second trailing edge section end and/or to the trailing edge of the wind turbine blade.

The trailing edge section comprises a first larger surface and a second larger surface. The trailing edge section further has a thickness, defined between the first larger surface and the second larger surface.

In preferred embodiments, the trailing edge section has a rectangular or substantially rectangular area on the first larger surface and on the second larger surface with two larger sides and two smaller sides defining the rectangular footprint on each of the surfaces. The two larger sides form part of the first trailing edge section end and the second trailing edge section end, respectively.

The trailing edge section may extend along part of the span of the shell structure of the wind turbine blade or along the whole span of the shell structure of the wind turbine blade. Preferably, the trailing edge section extend at least along a tip section of the shell structure of the wind turbine blade, since most noise is typically created in this area.

In some embodiments, the first larger surface and the second larger surface correspond to the pressure side and the suction side of the shell structure of the wind turbine blade. In such embodiments, the thickness of the trailing edge section typically increases from the first trailing edge section end toward the second trailing edge section end.

In other embodiments, the first larger surface and the second larger surface correspond to the first upper surface and the first lower surface of the trailing edge panel. In such embodiments, the thickness of the trailing edge section is typically constant from the first trailing edge section end toward the second trailing edge section end. However, in some embodiment, the thickness of the trailing edge section may increase from the first trailing edge section end toward the second trailing edge section end.

In some embodiments, the trailing edge panel is a substantially rectangular plate comprising the plurality of slits, the plate having a uniform thickness or a substantially uniform thickness. In some embodiments, the trailing edge panel has a length, a width and a thickness. The length and width each define the area of the first upper surface and the first lower surface of the trailing edge panel. The thickness of the trailing edge panel is defined between the first upper surface and the first lower surface. In some embodiments, the thickness of the trailing edge panel is constant or substantially constant. In such embodiments, there may be no difference between the attachment section and the trailing edge section, other than the fact that the trailing edge section comprises slits and the attachment section does not. Thus, the attachment section and the trailing edge section are only divided by an invisible “line” determined by which part of the trailing edge panel is attached to the wind turbine blade. This line may be defined at the end of the first plurality of slits most distal from the first trailing edge section end. Thus, the trailing edge panel may have a comb-like structure.

In some embodiments, the trailing edge panel further comprises a raised platform on the trailing edge section. This raised platform may have a constant thickness or taper from the attachment section toward the first trailing edge section end. Such a raised platform may be advantageous for attaching the trailing edge panel to the trailing edge of the shell structure of the wind turbine blade, since a dent would be defined between the raised platform and the attachment section in the trailing edge, which would provide guidance for arranging the trailing edge panel in contact with the trailing edge of the shell structure of the wind turbine blade. Furthermore, such raised platform may remove the step that may be created from the second side of the wind turbine blade, e.g. the pressure side, to the trailing edge panel when attaching the trailing edge panel to the first side, e.g. the suction side, of the shell structure of the wind turbine blade. This may further reduce the noise created at the trailing edge due to wind fluctuations at the step.

In some embodiments, the trailing edge panel is made of a fibre-reinforced polymer material, a polymer material or any other suitable material.

In preferred embodiments, the trailing edge panel is rigid. However, the trailing edge panel may also be flexible.

The plurality of slits may also be referred to as simply “the slits” herein.

The trailing edge section may include from between 2-20 groups of slits, wherein each group of slits have different sizes. The first plurality of slits is one group, and the second plurality of slits is another group.

In some embodiments, the plurality of slits further includes a third plurality of slits extending a third distance from the first trailing edge section end toward the second trailing edge section end, wherein the third distance is smaller than the second distance.

In some embodiments, the plurality of slits further include an Xth plurality of slits, wherein X is between 4-20, wherein each of the Xth plurality of slits extend an Xth distance from the first trailing edge section end towards the second trailing edge section end and wherein the distance from the first trailing edge section end toward the second trailing edge section end decreases the higher the number of X.

For example, if X=5, then the plurality of slits further include a fourth plurality of slits and a fifth plurality of slits, wherein each of the fourth plurality of slits extend a fourth distance from the first trailing edge section end towards the second trailing edge section end and wherein the fifth plurality of slits extend a fifth distance from the first trailing edge section end towards the second trailing edge section end. Furthermore, the fourth distance is smaller than the third distance and the fifth distance is smaller than the fourth distance. In this embodiment, the trailing edge section would include five groups of slits, wherein each group of slits has different sizes.

In this way, the trailing edge section of the invention comprises an increasing porosity from the second trailing edge section end toward the first trailing edge section end. This is advantageous because the pressure difference between airflow on the pressure side and the suction side of the blade is minimised toward the trailing edge, whereby the formation of vortices is decreased. The present inventors have found that a wind turbine blade comprising a trailing edge section with such a configuration effectively reduces noise.

A slit of the plurality of slits is preferably defined as material removed from the trailing edge section. Thus, each slit has a length, a width and a thickness defining a space in the trailing edge section from where material is removed. Preferably, a slit is not considered as a recess or removal of some material in the thickness direction of the trailing edge section. A slit is considered removal of all material in the thickness direction of the trailing edge section, such as to form a slit extending through the trailing edge section, from the first larger surface to the second larger surface.

Each of the plurality of slits is defined by a length, a width and a thickness.

Preferably, each of the plurality of slits is a long narrow cut or opening in the trailing edge of the wind turbine blade. By long and narrow is meant that the length is longer than the width. The length of a slit is preferably at least 3 times larger than the width of the slit, more preferably at least five times larger than the width of the slit.

The length of a slit corresponds to the distance that the slit extends from the first trailing edge section end toward the second trailing edge section end. The width of a slit is defined as the distance each slit extends in a direction perpendicular to the length. The thickness of a slit is defined as the distance between the first larger surface of the trailing edge section and the second larger surface of the trailing edge section. The length may be from 1 mm to between 5-30% of the chord-length of the shell structure i.e. the distance between the trailing edge and leading edge of the wind turbine blade. The width may be between 1 mm and 100 mm.

In preferred embodiments, the plurality of slits are straight in the length direction and straight in the thickness direction. In some embodiments, the plurality of slits are also straight in the width direction.

In preferred embodiments, each of the plurality of slits starts at the first trailing edge section end i.e. extends from the first trailing edge section end. In preferred embodiments, each of the plurality of slits starts at the trailing edge of the wind turbine blade. In some embodiments, the trailing edge of the wind turbine blade is the trailing edge of the shell structure. In other embodiments, the trailing edge of the wind turbine blade is an edge of the trailing edge panel arranged most distal from the leading edge of the wind turbine blade when the trailing edge panel is attached to the wind turbine blade.

In preferred embodiments, each of the plurality of slits is separated from adjacent slits of the plurality of slits, by material of the wind turbine blade. The material is either from the shell structure or from the trailing edge panel. Thus, in preferred embodiments, each of the plurality of slits is separated from adjacent slits, by material of the first trailing edge section, at the first trailing edge section end. In some embodiments, each of the plurality of slits is separated from adjacent slits, by material of the first trailing edge section, along their entire length.

However, in some embodiments, the areas between adjacent slits at the first trailing edge section end of the trailing edge section are shaped to having tapering portions or serrations. In other words, the width of the plurality of slits increases from the second trailing edge end toward the first trailing edge end, such as to form tapering portions of the trailing edge section between adjacent slits, but only in an outermost part of the area most proximal to the first trailing edge section end. In some embodiments, the width of the plurality of slits increases from the second trailing edge end toward the first trailing edge end, such as to form serrations in the trailing edge section between adjacent slits, but only in an outermost part of the area most proximal to the first trailing edge section end.

Thus, in some embodiments, the amount of material removed from different areas of the trailing edge section, i.e the porosity of the trailing edge section, decreases from the second trailing edge section end toward the first trailing edge section end.

In some embodiments, the trailing edge section can be divided into a plurality of areas comprising different porosities, including the area most proximal to the first trailing edge section end and an area most proximal to the second trailing edge section and optionally one or more intermediate areas, wherein the amount of material removed in each area is increasing from the area most proximal to the second trailing edge end toward the area most proximal to the first trailing edge end.

The amount of material removed in each area is correlated with the number of slits in each area.

The area most proximal to the first trailing edge section may be defined between the first trailing edge section end and a plane extending through the trailing edge section at a predetermined distance from the first trailing edge section end, wherein the predetermined distance corresponds to the length of the plurality of slits with the shortest length. The area most proximal to the first trailing edge section includes the highest number of slits or parts of slits.

The area most proximal to the second trailing edge section may be defined between the second trailing edge section end and a plane extending through the trailing edge section at a predetermined distance from the second trailing edge section end, wherein the predetermined distance corresponds to the length of the plurality of the first plurality of slits minus the length of the second plurality of slits. The area most proximal to the second trailing edge section includes the lowest number of slits or parts of slits.

The intermediate areas may be defined between the area most proximal to the first trailing edge and the area most proximal to the second trailing edge, based on the amount of material removed.

The number of intermediate areas depends on the number of groups of slits with different lengths. If there are seven groups of slits with different lengths, the number of intermediate areas is seven minus two. If there are two different groups of slits, the number of intermediate areas is zero. If there are thirteen different groups of slits, the number of intermediate areas is thirteen minus two.

In some embodiments, the plurality of slits are arranged substantially equidistantly along the spanwise direction of the trailing edge section.

In some embodiments, each of the first plurality of slits are arranged between two of the second plurality of slits, such that the first plurality of slits and second plurality of slits alternate along the trailing edge section.

In some embodiments, each of the first plurality of slits and each of the second plurality of slits are arranged between two of the third plurality of slits, such as to form a repeating pattern of slits along the trailing edge section, wherein the pattern comprises: one of the third plurality of slits, one of the second plurality of slits, one of the third plurality of slits, one of the first plurality of slits.

In some embodiments, the ratio between the number of the first plurality of slits and the second plurality of slits are approximately 1:1. This is particularly true for a high number of the plurality of slits. The higher the total number of the first and second plurality of slits, the closer the ratio between the number of the first plurality of slits and the number of the second plurality of slits comes to 1:1. With very few slits, such as only three slits in total, the ratio between the number of the first plurality of slits and the number of the second plurality of slits may be between 1:2 and 2:1.

In some embodiments, the ratio between the number of the second plurality of slits and number of the third plurality of slits is approximately 1:2.

As a general rule, it can be said that the ratio between the number of the Xth plurality of slits and the number of the (X+1)th plurality of slits is approximately 1:2, wherein X is between 3-19.

In some embodiments, the predetermined distance between the first trailing edge section end and the second trailing edge section end of the trailing edge section is between 5-30% of the chord-length of the shell structure i.e. the distance between the trailing edge and leading edge of the wind turbine blade comprising the trailing edge section.

In a second aspect, the present invention relates to a trailing edge panel comprising a trailing edge section and being configured to be attached to a wind turbine blade along at least part of the trailing edge.

In a second aspect, the present invention relates to a trailing edge panel configured to be attached at a trailing edge of a shell structure of a wind turbine blade, wherein the trailing edge panel comprises:
an attachment section configured to be attached to and extend from the trailing edge of the shell structure of the wind turbine blade and to an upstream position on a first blade side of the shell structure of the wind turbine blade,
a trailing edge section extending from the attachment section and configured to project out from the trailing edge of the shell structure of the wind turbine blade, wherein the trailing edge section is defined between
   a first trailing edge section end, wherein the first trailing edge section end is configured to extend along at least part of the span of the shell structure of the wind turbine blade and is the most distal end of the trailing edge section relative to the attachment section, and
   a second trailing edge section end, wherein the second trailing edge section end is configured to extend along at least part of the span of the shell structure of the wind turbine blade and is a plane going through the trailing edge panel defined at a predetermined distance from the first trailing edge section end toward the attachment section,
      and wherein the trailing edge section comprises a plurality of slits, including:
a first plurality of slits extending a first distance from the first trailing edge section end toward the second trailing edge section end, and
a second plurality of slits extending a second distance from the first trailing edge section end toward the second trailing edge section end, wherein the second distance is smaller than the first distance.

The first blade side of the wind turbine blade is the pressure side or the suction side.

In some embodiments, the trailing edge panel is a substantially rectangular plate comprising the plurality of slits, the plate optionally having a substantially uniform thickness. In some embodiments, the trailing edge panel has a length, a width and a thickness. The length and width each define the area of the first upper surface and the first lower surface of the trailing edge panel. The thickness of the trailing edge panel is defined between the first upper surface and the first lower surface. In some embodiments, the thickness of the trailing edge panel is constant. In such embodiments, there may be no difference between the attachment section and the trailing edge section, other than the fact that the trailing edge section comprises slits and the attachment section does not. Thus, the attachment section and the trailing edge section are only divided by an invisible “line” determined by which part of the trailing edge panel is configured to be attached to the wind turbine blade. This line may be defined at the end of the first plurality of slits most distal from the first trailing edge section end. Thus, the trailing edge panel may have a comb-like structure.

In some embodiments, the trailing edge panel further comprises a raised platform on the trailing edge section. This raised platform may have a constant thickness or taper from the attachment section toward the first trailing edge section end. Such a raised platform may be advantageous for attaching the trailing edge panel to the trailing edge of the shell structure of the wind turbine blade, since a dent would be defined between the raised platform and the attachment section in the trailing edge, which would provide guidance for arranging the trailing edge panel in contact with the trailing edge of the shell structure of the wind turbine blade. Furthermore, such raised platform may remove the step that may be created from the second side of the wind turbine blade, e.g. the pressure side and the, to the trailing edge panel when attaching the trailing edge panel to the first side, e.g. the suction side, of the shell structure of the wind turbine blade. This may further reduce the noise created at the trailing edge due to wind fluctuations at the step.

In some embodiments, the trailing edge panel is made of a fibre-reinforced polymer material, a polymer material or any other suitable material.

In preferred embodiments, the trailing edge panel is rigid. However, the trailing edge panel may also be flexible.

It will be understood that any of the above-described features of the first aspect of the invention also apply to the second aspect of the invention. In particular, embodiments described with regard to the trailing edge section of the wind turbine blade may also apply to the trailing edge panel configured to be attached to a wind turbine blade and vice versa.

### DETAILED DESCRIPTION OF THE INVENTION

The invention is explained in detail below with reference to embodiments shown in the drawings, in which

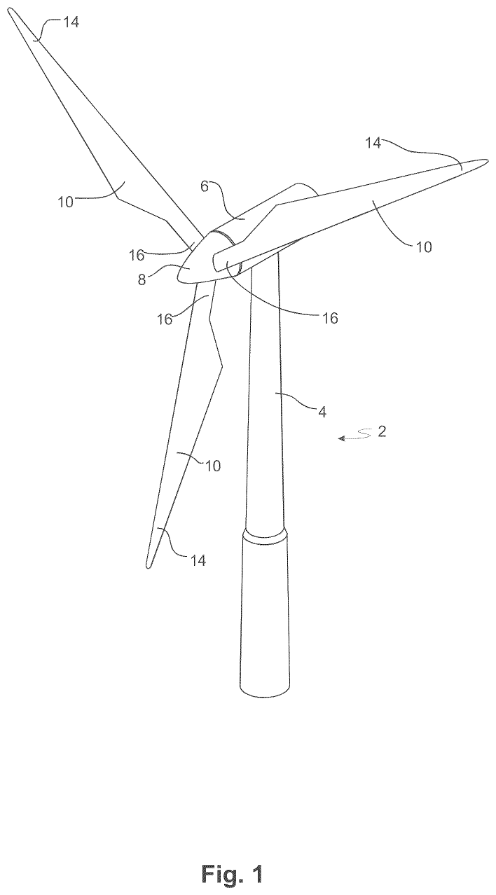

FIG. 1 is a schematic diagram illustrating a wind turbine,

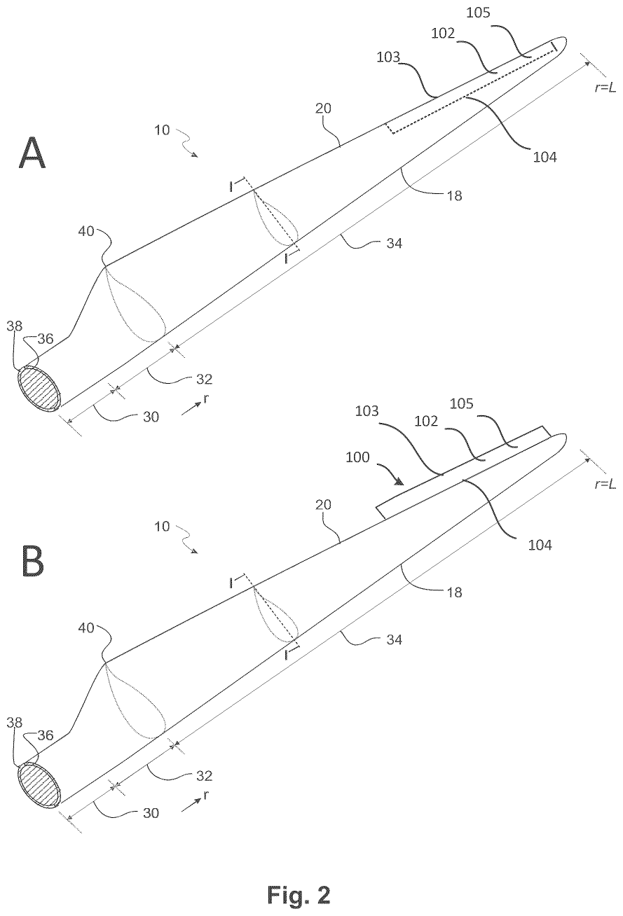

FIG. 2 is a schematic diagram illustrating two different embodiments of a wind turbine blade according to the present invention,

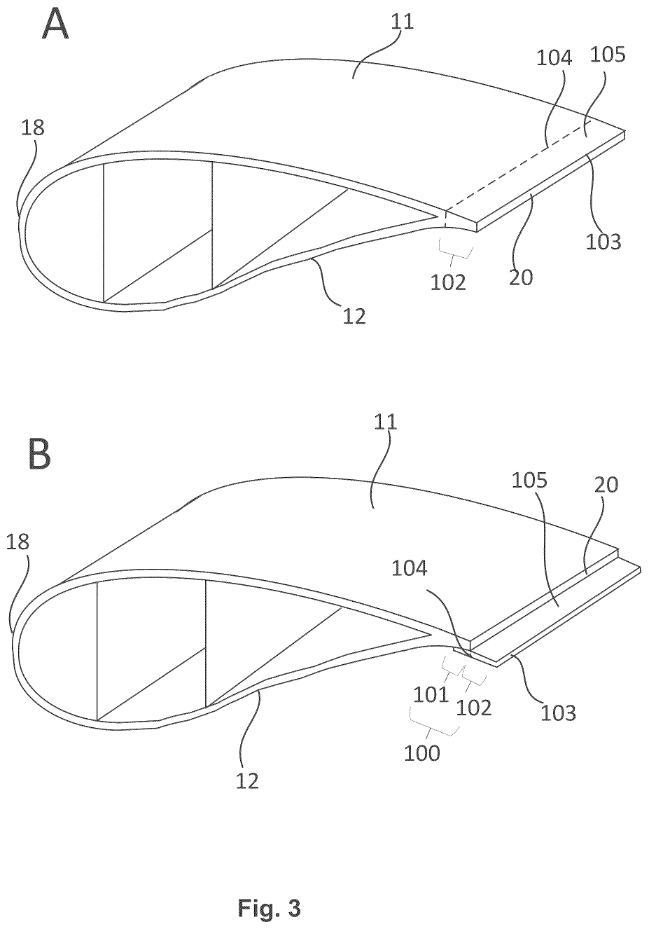

FIG. 3 is a schematic diagram illustrating a cross-sectional view of two different embodiments of part of a wind turbine blade according to the present invention,

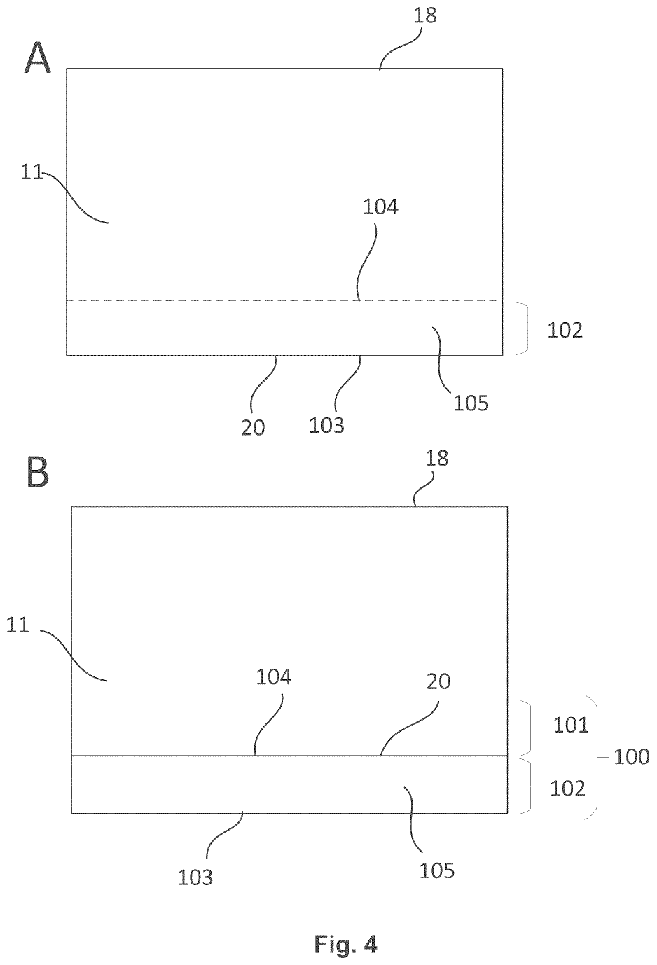

FIG. 4 is a schematic diagram illustrating a top-view of two different embodiments of part of a wind turbine blade according to the present invention,

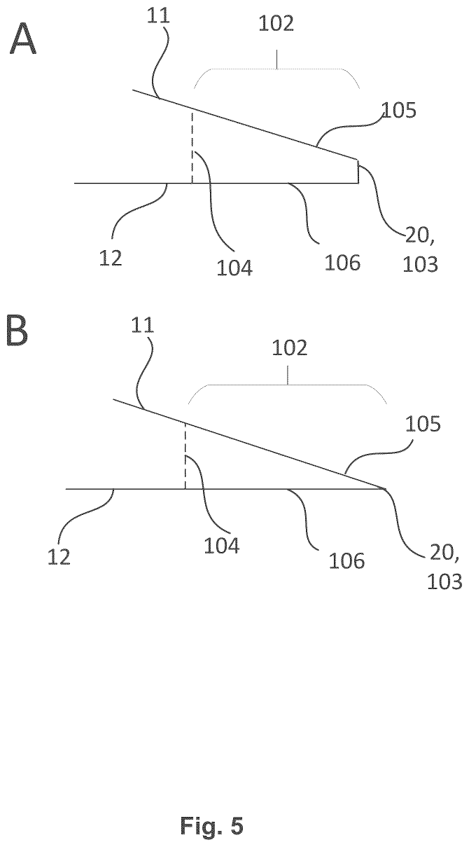

FIG. 5 is a schematic diagram illustrating a cross-sectional side-view of two different embodiments of the trailing edge section in a shell structure of a wind turbine blade according to the present invention,

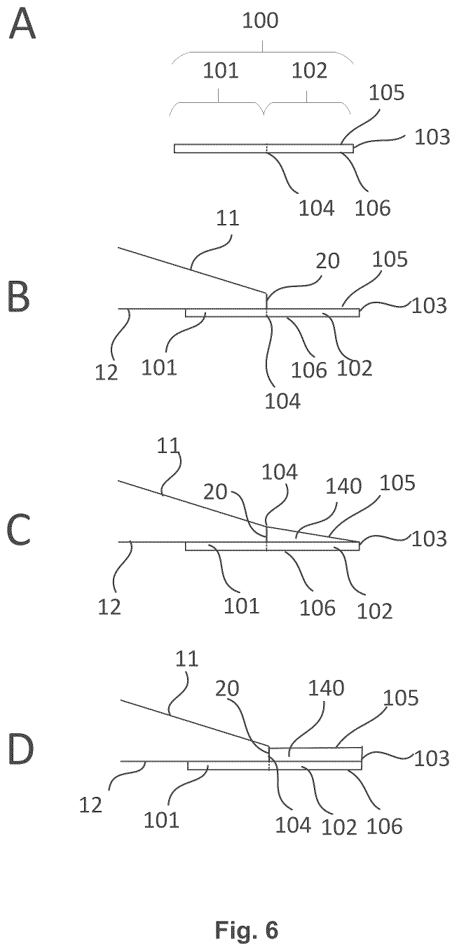

FIG. 6 is a schematic diagram illustrating a cross-sectional side-view of three different embodiments of a trailing edge panel attached to the shell structure of a wind turbine blade according to the present invention,

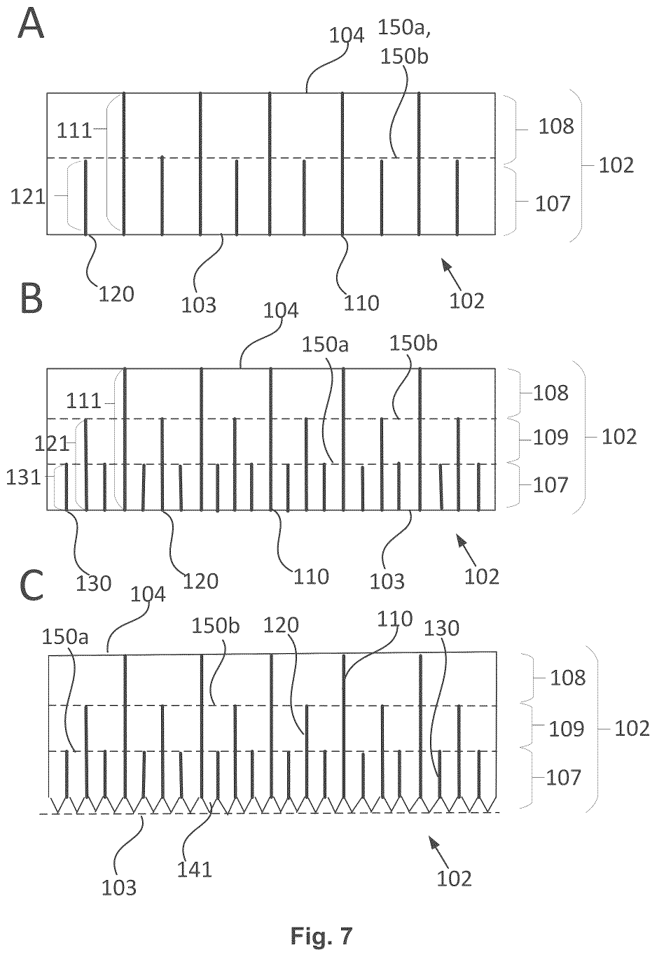

FIG. 7 is a schematic diagram illustrating a top-view of three different embodiments of the trailing edge section of a wind turbine blade according to the present invention,

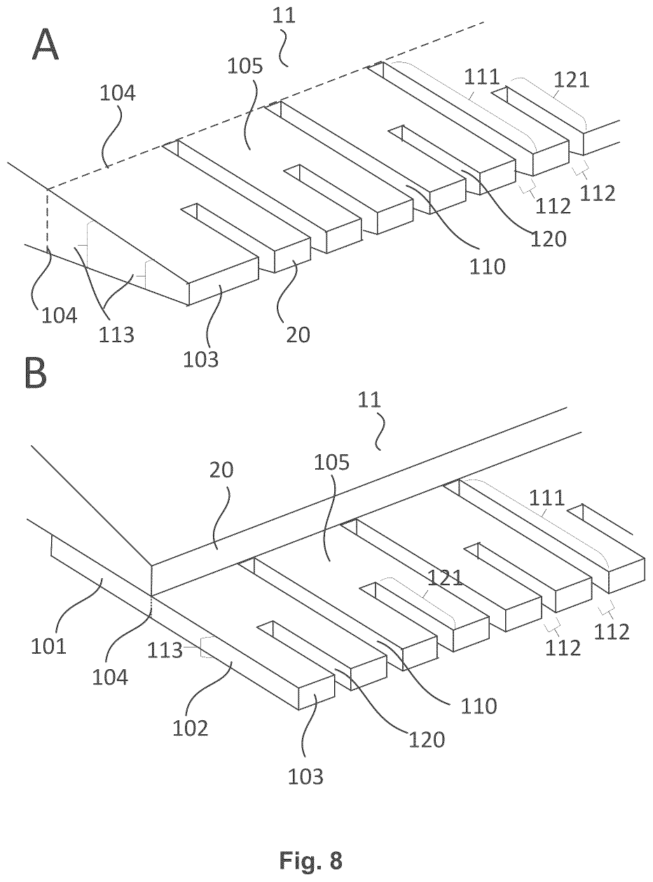

FIG. 8 is a schematic diagram illustrating a three-dimensional view of two different embodiments of part of the trailing edge section of a wind turbine blade according to the present invention, and

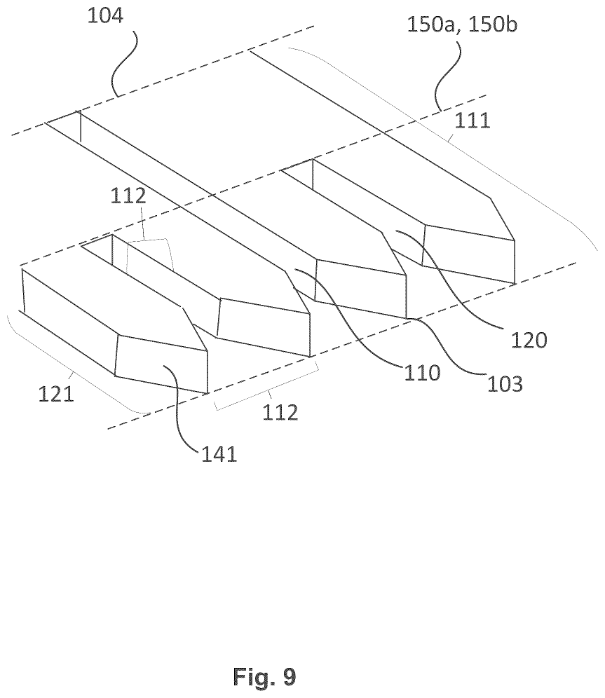

FIG. 9 is a schematic diagram illustrating a three-dimensional view of an embodiment of part of the trailing edge section of a wind turbine blade according to the present invention.

### DETAILED DESCRIPTION

FIG. 1 illustrates a conventional modern upwind wind turbine according to the so-called “Danish concept” with a tower 4, a nacelle 6 and a rotor with a substantially horizontal rotor shaft. The rotor includes a hub 8 and three blades 10 extending radially from the hub 8, each having a blade root 16 nearest the hub and a blade tip 14 furthest from the hub 8.

FIG. 2 shows a schematic view of two embodiments of a wind turbine blade 10 according to the invention.

The wind turbine blade 10 has the shape of a conventional wind turbine blade and comprises a root region 30 closest to the hub, a profiled or an airfoil region 34 furthest away from the hub and a transition region 32 between the root region 30 and the airfoil region 34. The blade 10 comprises a leading edge 18 facing the direction of rotation of the blade 10, when the blade is mounted on the hub, and a trailing edge 20 facing the opposite direction of the leading edge 18.

The airfoil region 34 (also called the profiled region) has an ideal or almost ideal blade shape with respect to generating lift, whereas the root region 30 due to structural considerations has a substantially circular or elliptical cross-section, which for instance makes it easier and safer to mount the blade 10 to the hub. The diameter (or the chord) of the root region 30 may be constant along the entire root area 30. The transition region 32 has a transitional profile gradually changing from the circular or elliptical shape of the root region 30 to the airfoil profile of the airfoil region 34. The chord length of the transition region 32 typically increases with increasing distance r from the hub. The airfoil region 34 has an airfoil profile with a chord extending between the leading edge 18 and the trailing edge 20 of the blade 10. The width of the chord decreases with increasing distance r from the hub.

A shoulder 40 of the blade 10 is defined as the position, where the blade 10 has its largest chord length. The shoulder 40 is typically provided at the boundary between the transition region 32 and the airfoil region 34.

It should be noted that the chords of different sections of the blade normally do not lie in a common plane, since the blade may be twisted and/or curved (i.e. pre-bent), thus providing the chord plane with a correspondingly twisted and/or curved course, this being most often the case in order to compensate for the local velocity of the blade 10 being dependent on the radius from the hub 8.

The wind turbine blade 10 of the present invention has a profiled contour including a pressure side 12 and a suction side 11 and a leading edge 18 and a trailing edge 20 with a chord having a chord length extending therebetween, the wind turbine blade 10 extending in a spanwise direction between a root end 16 and a tip end 14.

Furthermore, the wind turbine blade 10 of the present invention comprises a trailing edge section 102, which is defined between a first trailing edge section end 103 and a second trailing edge section end 104.

As can be seen in FIG. 2, the trailing edge section 102 has a first larger surface 105 and a second larger surface 106. The trailing edge section 102 has a rectangular or substantially rectangular area on the first larger surface 105 and on the second larger surface 106, with two larger sides and two smaller sides defining the rectangular footprint on each of the larger surfaces. The two larger sides form part of the first trailing edge section end 103 and the second trailing edge section end 104, respectively. A thickness of the trailing edge section is defined between the first larger surface 105 and the second larger surface 106.

The trailing edge section 102 comprises a plurality of slits, including: a first plurality of slits 110 extending a first distance 111 (not shown in FIG. 2) from the first trailing edge section end 103 toward the second trailing edge section end 104, and a second plurality of slits 120 extending a second distance 121 from the first trailing edge section end 103 toward the second trailing edge section end 104, wherein the second distance 121 (not shown in FIG. 2) is smaller than the first distance 111.

In some embodiments, the trailing edge section 102 is part of the shell structure of the wind turbine blade and in other embodiments (FIG. 2A), the trailing edge section 102 is part of a trailing edge panel 100 attached to the shell structure of the wind turbine blade (FIG. 2B).

FIG. 2A is a schematic illustration of an embodiment of a wind turbine blade according to the invention, where the wind turbine blade comprises a trailing edge section 102 as part of the shell structure of the wind turbine blade. In FIG. 2A, the trailing edge section 102 is illustrated by a dotted rectangular section extending along part of the trailing edge of the wind turbine blade. In other embodiments, the trailing edge section 102 may extend along a larger part of the trailing edge, such as along the whole trailing edge, or along a smaller part of the trailing edge.

As also illustrated in FIG. 3A, which shows a cross-sectional view of a wind turbine blade similar to that of FIG. 2A, the trailing edge section 102 comprises a first trailing edge section end 103 corresponding to the trailing edge of the wind turbine blade. As can be seen in FIG. 3A, the first trailing edge section end 103 is defined at an outermost edge of the wind turbine blade most distal to the leading edge 18 of the wind turbine blade. Furthermore, the trailing edge section 102 comprises a second trailing edge section end 104 extending along at least part of the span of the shell structure of the wind turbine blade and is a plane going through the shell structure of the wind turbine blade defined at a predetermined distance from the first trailing edge section end 103 toward the leading edge of the shell structure of the wind turbine blade. The second trailing edge end is illustrated by a notional dotted plane going through the shell structure of the wind turbine blade. The second trailing edge section end 104 is defined between the first trailing edge section end and the leading edge of the wind turbine blade.

In the embodiments of FIGS. 2A and 3A, the first larger surface 105 and a second larger surface 106 of the trailing edge section 102 form part of the pressure side and the suction side of the shell structure of the wind turbine blade and the thickness of the trailing edge section 102 increases from the first trailing edge section end 103 toward the second trailing edge section end 104.

FIG. 2B is a schematic illustration of another embodiment of a wind turbine blade according to the invention. In this embodiment, the trailing edge section 102 is still part of the wind turbine blade, but not part the shell structure of the wind turbine blade. Rather, the trailing edge section 102 is part of a trailing edge panel 100 attached to the shell structure of the wind turbine blade, e.g. as an aerodynamic add-on. This is also illustrated in FIG. 3B, which shows a cross-sectional view of a wind turbine blade similar to that of FIG. 2B, where it further can be seen that the trailing edge panel 100 comprises a trailing edge section 102 and an attachment section 101.

As can be seen in FIG. 3B, the attachment section 101 is attached to and extending from the trailing edge 20 of the wind turbine blade and to an upstream position on a first blade side of the wind turbine blade, in this case the pressure side, whereas the trailing edge section 102 extends from the attachment section 101 and projects out from the trailing edge 20 of the shell structure of the wind turbine blade. In FIGS. 2B and 3B, the trailing edge panel 100 is a uniformly thick and substantially rectangular plate and the attachment section 101 and trailing edge section 102 are separated by a notional line. In this embodiment, there is no noticeable difference between the attachment section 101 and the trailing edge section 102. Thus, the attachment section 101 and the trailing edge section 102 are only divided by an invisible “line” determined by which part of the trailing edge panel 100 is attached to the wind turbine blade.

The trailing edge section 102 of FIG. 3B also comprises a first trailing edge section end 103 and a second trailing edge section end 104. As can be seen in FIG. 3B, the first trailing edge section end 103 is defined at an outermost edge of the wind turbine blade most distal to the leading edge 18 of the wind turbine blade and the second trailing edge section end 104 is defined between the first trailing edge section end and the leading edge of the wind turbine blade. In FIG. 3B, the first trailing edge section end 103 corresponds to the trailing edge 20 of the wind turbine blade but not to the trailing edge of the shell structure. It can be seen in FIG. 3B that the first trailing edge section end 103 extends along part of the span of the shell structure of the wind turbine blade and is the most distal end of the trailing edge section 102 relative to the attachment section 101. The second trailing edge section end 104 extends along part of the span of the shell structure of the wind turbine blade parallel to the first trailing edge section end 103 and is a plane going through the trailing edge panel 100 defined at a predetermined distance from the first trailing edge section end 103 toward the attachment section 101.

Particularly, the second trailing edge section end 104 of the trailing edge panel 100 is arranged below the trailing edge of the shell structure of the wind turbine blade, such that the second trailing edge section end 104 is defined by a plane extending from the trailing edge of the shell structure of the wind turbine blade and through the trailing edge panel 100, which is attached to the trailing edge of the shell structure of the wind turbine blade.

In the embodiment of FIGS. 2B and 3B, the first larger surface 105 and a second larger surface 106 of the trailing edge section 102 are part of an upper surface and a lower surface of the trailing edge panel 100, respectively. In this embodiment, the thickness of the trailing edge section 102 is constant from the first trailing edge section end 103 toward the second trailing edge section end 104. However, in other embodiments, such as the embodiment shown in FIG. 6C, the thickness of the trailing edge section 102 is increasing from the first trailing edge section end 103 toward the second trailing edge section end 104.

FIGS. 4A and 4B are schematic illustrations of a top-view of the embodiments illustrated in FIGS. 3A and 3B, respectively.

FIGS. 5A and 6B are schematic illustrations of a side-view of the embodiments illustrated in FIGS. 3A and 3B, respectively.

Furthermore, FIG. 5B is an alternative embodiment of the trailing edge of a wind turbine blade, where the trailing edge is tapered in thickness.

FIG. 6A is a schematic side-view of a trailing edge panel 100 configured to be attached to a wind turbine blade and comprising an attachment part and a trailing edge part as described in relation to previous figures.

FIGS. 6C and 6D are also schematic side-views of embodiments of a trailing edge panel 100 attached to a wind turbine blade. In these embodiments, the trailing edge panel 100 further comprises a raised platform 140 on the trailing edge section. This raised platform 140 may have a constant thickness, as illustrated in FIG. 6D, or taper from the attachment section 101 toward the first trailing edge section end 103, as illustrated in FIG. 6C. Such a raised platform 140 may be advantageous for attaching the trailing edge panel 100 to the trailing edge of the shell structure of the wind turbine blade, since a dent would be defined between the raised platform 140 and the attachment section 101 in the trailing edge, which would provide alignment for arranging the trailing edge panel 100 in contact with the trailing edge of the shell structure of the wind turbine blade. Furthermore, such raised platform 140 may remove the step that may be created from the second side of the wind turbine blade, e.g. the pressure side, to the trailing edge panel 100 when attaching the trailing edge panel 100 to the first side, e.g. the suction side, of the shell structure of the wind turbine blade. This may further reduce the noise created at the trailing edge due to wind fluctuations at the step.

The trailing edge section 102 of the invention further comprises a plurality of slits. The plurality of slits may also be referred to as simply “the slits” herein. The plurality of slits includes a first plurality of slits 110 extending a first distance 111 (not shown in FIG. 6) from the first trailing edge section end 103 toward the second trailing edge section end 104, and a second plurality of slits 120 extending a second distance 121 from the first trailing edge section end 103 toward the second trailing edge section end 104, wherein the second distance 121 (not shown in FIG. 6) is smaller than the first distance 111. However, the plurality of slits are not shown in FIG. 2-6 to simplify the drawings. Instead, different embodiment of the arrangement of the plurality of slits are illustrated in FIGS. 7-9.

FIG. 7 shows schematic top views of different embodiments of a trailing edge section 102 defined between a first trailing edge section end 103 and a second trailing edge section end 104. The embodiments illustrated in FIG. 7 are embodiments of a trailing edge section 102 which may be part of the shell structure of a wind turbine blade or part of a trailing edge panel 100. The thick black lines illustrate the plurality of slits in the trailing edge section 102.

In FIG. 7A, the trailing edge section 102 comprises a first plurality of slits 110 and a second plurality of slits 120. The first plurality of slits 110 extend a first distance 111 from the first trailing edge section end 103 toward the second trailing edge section end 104, and the second plurality of slits 120 extend a second distance 121 from the first trailing edge section end 103 toward the second trailing edge section end 104. The second distance 121 is smaller than the first distance 111.

Each of the first plurality of slits 110 are arranged between two of the second plurality of slits 120, such that the first plurality of slits 110 and second plurality of slits 120 alternate along the trailing edge section. An exception to this may be at the two outermost slits of the trailing edge section, which may be either part of the first plurality of slits 110 or part of the second plurality of slits 120. However, in FIG. 7A the two outermost slits are part of the second plurality of slits 120.

The ratio between the number of the first plurality of slits 110 and the second plurality of slits 120 is approximately 1:1. However, since the outermost slits are part of the second plurality of slits 120, the number of the second plurality of slits 120 is slightly higher than the number of the first plurality of slits 110, e.g. six versus five, respectively, as shown in the figure. However, if the total number of the plurality of slits is higher, the ratio between the number of the first plurality of slits 110 and the second plurality of slits 120 will become closer to 1:1.

Even though the plurality of slits are illustrated as thick black lines in relation to FIG. 7, a slit is herein defined as material removed from the trailing edge section 102. Furthermore, each of the plurality of slits are defined by a length, a width and a thickness.

As can be seen in FIG. 7A, the trailing edge section 102 may be divided into two areas 107, 108, including an area most proximal to the first trailing edge section end and an area most proximal to the second trailing edge section. The amount of material removed in each area is correlated with the number of slits in each area.

The area 107 most proximal to the first trailing edge section end 103 may be defined between the first trailing edge section end 103 and a plane 150a extending through the trailing edge section 102 at a predetermined distance from the first trailing edge section end 103, wherein the predetermined distance corresponds to the length of the plurality of slits with the shortest length, in this case the length of the second plurality of slits 120. The area 107 most proximal to the first trailing edge section end include the highest number of slits or parts of slits.

The area 108 most proximal to the second trailing edge section end 104 may be defined between the second trailing edge section end 104 and a plane 150b extending through the trailing edge section 102 at a predetermined distance from the second trailing edge section end 104, wherein the predetermined distance corresponds to the length of the plurality of the first plurality of slits 110 minus the length of the second plurality of slits 120. The area 108 most proximal to the second trailing edge section end 104 includes the lowest number of slits or parts of slits.

The number of slits in each area is increasing from the area most proximal to the second trailing edge end toward the area most proximal to the first trailing edge end. In FIG. 7A, the area 107 most proximal to the first trailing edge section end 103 includes eleven slits, where five of the eleven slits are part of the first plurality of slits 110 and six of the eleven slits are part of the second plurality of slits 120.

As a result, the amount of material removed from different areas of the trailing edge section and hence the porosity of the trailing edge section increases from the second trailing edge section end 104 toward the first trailing edge section end 103. The present inventors have found that this gradual increase in porosity leads to a significant noise reduction at the wind turbine blade when in use.

In FIG. 7B, the trailing edge section 102 comprises a first plurality of slits 110, a second plurality of slits 120 and a third plurality of slits 130. The first plurality of slits 110 extend a first distance 111 from the first trailing edge section end 103 toward the second trailing edge section end 104, and the second plurality of slits 120 extend a second distance 121 from the first trailing edge section end 103 toward the second trailing edge section end 104. Furthermore, the trailing edge section 102 includes a third plurality of slits 130 extending a third distance 131 from the first trailing edge section end 103 toward the second trailing edge section end 104. The second distance 121 is smaller than the first distance 111 and the third distance 131 is smaller than the first and second distance 121.

Each of the first plurality of slits 110 and each of the second plurality of slits 120 are arranged between two of the third plurality of slits 130, such as to form a repeating pattern of slits along the trailing edge section, wherein the pattern comprises: one of the third plurality of slits 130, one of the second plurality of slits 120, one of the third plurality of slits 130, one of the first plurality of slits 110 and so on. As can be seen in FIG. 7B, this pattern is repeating itself in from left to right and from right to left. However, the outermost slits of the trailing edge section 102 may deviate from the pattern.

In FIG. 7B, the ratio between the number of the first plurality of slits 110 and the second plurality of slits 120 is approximately 1:1 with five slits being part of the first plurality of slits 110 and six slits being part of the second plurality of slits 120. Furthermore, the ratio between the number of the second plurality of slits 120 and the third plurality of slits 130 is approximately 1:2, with six slits being part of the second plurality of slits 120 and twelve slits being part of the third plurality of slits 130.

Even though not illustrated, the trailing edge section 102 according to the present invention may comprise up to twenty groups of slits or more, where each group of slits have different lengths. In other words, in some embodiments, the plurality of slits further include an Xth plurality of slits, wherein X is between 4-20, wherein each of the Xth plurality of slits extend an Xth distance from the first trailing edge section end 103 towards the second trailing edge section end 104 and wherein the Xth distance, i.e. the length of the Xth plurality of slits, decreases the higher the number of X. Furthermore, the ratio between the number of the Xth plurality of slits and the number of (X+1)th plurality of slits is approximately 1:2, wherein X is between 3-19.

As can be seen in FIG. 7B, the trailing edge section 102 may be divided into three areas 107, 108, 109 including an area 107 most proximal to the first trailing edge section end 103, an area 108 most proximal to the second trailing edge section 104, and an intermediate area 109.

The area 107 most proximal to the first trailing edge section end 103 may be defined between the first trailing edge section end 103 and a plane 150a extending through the trailing edge section 102 at a predetermined distance from the first trailing edge section end 103, wherein the predetermined distance corresponds to the length of the plurality of slits with the shortest length, in this case the length of the third plurality of slits 130. The area 107 most proximal to the first trailing edge section end 103 includes the highest number of slits or parts of slits.

The area 108 most proximal to the second trailing edge section end 104 may be defined between the second trailing edge section end 104 and a plane 150b extending through the trailing edge section 102 at a predetermined distance from the second trailing edge section end 104, wherein the predetermined distance corresponds to the length of the plurality of the first plurality of slits 110 minus the length of the second plurality of slits 120. The area 108 most proximal to the second trailing edge section end 104 includes the lowest number of slits or parts of slits.

Furthermore, an intermediate area 109 is defined between the area most proximal to the first trailing edge and the area most proximal to the second trailing edge. The number of intermediate areas 109 depends on the number of groups of slits with different lengths. In this case, there are three groups of slits with different lengths, the number of intermediate areas 109 is three minus two, which equals one.

As a result, the amount of material removed from different areas of the trailing edge section and hence the porosity of the trailing edge section increases from the second trailing edge section end 104 toward the first trailing edge section end 103. The present inventors have found that this gradual increase in porosity leads to a significant noise reduction at the wind turbine blade when in use.

The trailing edge section 102 illustrated in FIG. 7C is similar to that of FIG. 7B, except from the fact that areas between adjacent slits at the first trailing edge section end of the trailing edge section are shaped to having tapering portions or serrations. Thus, a width 112 of the plurality of slits 110, 120, 130 increases toward the first trailing edge section end 103, such as to form tapering portions or serrations 141 at the trailing edge section 102 between adjacent slits 110, 120, 130, but only in an outermost part of the area 107 most proximal to the first trailing edge section end 103. In this way, the trailing edge section 102 of FIG. 7C has a serrated first trailing edge section end 103, but each tapering portion or serration 141 is separated by a slit.

FIGS. 8 and 9 are schematic illustrations of a perspective close-up view of trailing edge sections 102 according to different embodiments of the invention.

FIG. 8A illustrates an embodiment of a trailing edge section 102 of a wind turbine blade similar to that of FIGS. 2A, 3A, 4A and 5A but shows that the plurality of slits 110, 120 correspond to removal of material from the wind turbine blade 10 itself and that the amount of removed material increases from the second trailing edge section end 104 toward the first trailing edge section end 103.

FIG. 8B illustrates an embodiment of a trailing edge section 102 of a trailing edge panel 100 attached to a wind turbine blade similar to that of FIGS. 2B, 3B, 4B and 5B, but shows that the plurality of slits 110, 120 correspond to removal of material from the wind turbine blade and that the amount of removed material increases from the second trailing edge section end 104 toward the first trailing edge section end 103.

Each of the plurality of slits is defined by a length, a width 112 and a thickness 113. The length of each slit corresponds to the distance 111, 121, 131 that each slit 110, 120, 130 extends from the first trailing edge section end 103 toward the second trailing edge section end 104. The width 112 is defined as a distance perpendicular on the distance each slit extends from the first trailing edge section end 103 toward the second trailing edge section end 104. The thickness is defined as a distance between the first larger surface 105 of the trailing edge section 102 and the second larger surface 106 of the trailing edge section 102.

In the embodiment of FIG. 8A, the first larger surface 105 of the trailing edge section 102 is part of the pressure side of the wind turbine blade and the second larger surface 106 of the trailing edge section 102 is part of the suction side of the wind turbine blade, and the thickness of each slit 110, 120 increases from the first trailing edge section end 103 toward the second trailing edge section end 104. The width of the slits in FIG. 8A is constant and the same for all slits 110, 120.

In the embodiment of FIG. 8B, the thickness 113 of each slit 110, 120 is constant from the first trailing edge section end 103 toward the second trailing edge section end 104. However, in other embodiments, such as the embodiment illustrated in FIG. 6C, the thickness of each slit 110, 120 may increase from the first trailing edge section end 103 toward the second trailing edge section end 104. The width of the slits in FIG. 8B is constant and the same for all slits 110, 120.

FIG. 9 is a close up of an embodiment similar to that of FIG. 8A, except from the fact that areas between adjacent slits at the first trailing edge section end of the trailing edge section are shaped to having tapering portions or serrations. In this way, the width 112 is not constant along the whole length of all slits 110, 120. In contrast, the width 112 of the plurality of slits 110, 120 is constant along most of the length but increases toward the first trailing edge section end 103, such as to form tapering portions or serrations 141 of the trailing edge section 102 between adjacent slits 110, 120, but only in an outermost part of the area most proximal to the first trailing edge section end 107. In this way, the trailing edge section 102 of FIG. 7C has a serrated first trailing edge section end 103, but each tapering portion or serration 141 is separated by a slit 110, 120.

As can be seen in all figures, the first trailing edge section end 103 is defined as a substantially straight line or surface defined at an outermost edge of the wind turbine blade most distal to the leading edge 18 of the wind turbine blade. The second trailing edge section end 104 is defined between the first trailing edge section end and the leading edge of the wind turbine blade. The first trailing edge section end is parallel or substantially parallel with the second trailing edge section end 104 and with the trailing edge of the wind turbine blade.

In FIG. 8A, the first trailing edge section end 103 may be defined as a plane or a line, extending in parallel with the trailing edge of the shell structure, since the outermost part of the wind turbine blade most distal to the leading edge of the wind turbine blade is a plurality of surfaces defining the trailing edge of the shell structure. In this embodiment, the first trailing edge section end 103 is the plane or line that can be drawn between the plurality of surfaces.

In FIG. 8B, the first trailing edge section end 103 may be defined as a plane or a line, extending in parallel with the trailing edge of the shell structure, since the outermost part of the wind turbine blade most distal to the leading edge of the wind turbine blade is a plurality of surfaces defining the trailing edge of the wind turbine blade. In this embodiment, the first trailing edge section end 103 is the plane or line that can be drawn between the plurality of surfaces.

The first trailing edge section comprises a solid part comprising material as well as areas where material is removed. The areas where material is removed is the plurality of slits. As can be seen in all figures illustrating the plurality of slits, the plurality of slits all start from and extend from the first trailing edge section end 103. The plurality of slits are substantially long and narrow cuts or openings in the first trailing edge section, starting from the first trailing edge section end. As can also be seen in all figures illustrating the slits, two adjacent slits are always separated by material of the trailing edge section at the first trailing edge section end, preferably along their entire length i.e., two adjacent slits are always separated along their entire length by the solid part of the trailing edge section.

The disclosure has been described with reference to a preferred embodiment. However, the scope of the invention is not limited to the illustrated embodiment, and alterations and modifications can be carried out without deviating from the scope of the invention. Throughout the description, the use of the terms “first”, “second”, “third”, “fourth” etc. does not necessarily imply any particular order or importance, but are included to identify individual elements. Furthermore, the labelling of a first element does not imply the presence of a second element and vice versa.

### ITEMIZED LIST OF EMBODIMENTS

1. A wind turbine blade comprising a shell structure having a profiled contour including a pressure side and a suction side and a leading edge and a trailing edge with a chord having a chord length extending therebetween, the shell structure of the wind turbine blade extending in a spanwise direction between a root end and a tip end, wherein the wind turbine blade comprises a trailing edge section defined between a first trailing edge section end and a second trailing edge section end, wherein the trailing edge section comprises a plurality of slits, including:
   a first plurality of slits extending a first distance from the first trailing edge section end toward the second trailing edge section end, and
   a second plurality of slits extending a second distance from the first trailing edge section end toward the second trailing edge section end, wherein the second distance is smaller than the first distance, and
wherein the trailing edge section is part of the shell structure of the wind turbine blade or wherein the trailing edge section is part of a trailing edge panel attached to the shell structure of the wind turbine blade.
2. A wind turbine blade according to item 1, wherein the first trailing edge section end is defined at an outermost edge of the wind turbine blade most distal to the leading edge of the wind turbine blade.
3. A wind turbine blade according to item 1 or 2, wherein the second trailing edge section end is defined between the first trailing edge section end and the leading edge of the wind turbine blade.
4. A wind turbine blade according to any of the preceding items, wherein each of the plurality of slits is separated from adjacent slits, by material of the first trailing edge section, at the first trailing edge section end.
5. A wind turbine blade according to any of the preceding items, wherein the first trailing edge section end is parallel or substantially parallel with the second trailing edge section end and/or with the trailing edge of the wind turbine blade.
6. A wind turbine blade according to any of the preceding items, wherein the first trailing edge section end corresponds to the trailing edge of the wind turbine blade.
7. A wind turbine blade according to any of the preceding items, wherein the trailing edge section is part of the shell structure of the wind turbine blade and the first trailing edge section end corresponds to the trailing edge of the shell structure of the wind turbine blade and the second trailing edge section end extends along at least part of the span of the shell structure of the wind turbine blade and is a plane going through the shell structure of the wind turbine blade defined at a predetermined distance from the first trailing edge section end toward the leading edge of the shell structure of the wind turbine blade.
8. A wind turbine blade according to any of items 1-6, wherein the trailing edge section is part of a trailing edge panel attached to the shell structure of the wind turbine blade, wherein the trailing edge panel comprises:
   an attachment section being attached to and extending from the trailing edge of the shell structure of the wind turbine blade and to an upstream position on a first blade side of the shell structure of the wind turbine blade,
   the trailing edge section extending from the attachment section and projecting out from the trailing edge of the shell structure of the wind turbine blade, wherein
      the first trailing edge section end extends along at least part of the span of the shell structure of the wind turbine blade and is the most distal end of the trailing edge section relative to the attachment section, and
      the second trailing edge section end extends along at least part of the span of the shell structure of the wind turbine blade and is a plane going through the trailing edge panel defined at a predetermined distance from the first trailing edge section end toward the attachment section.
9. A wind turbine blade according to any of the preceding items, wherein the trailing edge section extends along part of the span of the shell structure of the wind turbine blade or along the whole span of the shell structure of the wind turbine blade, preferably, the trailing edge section extends at least along a tip section of the shell structure of the wind turbine blade.
10. A wind turbine blade according to any of the preceding items, wherein the trailing edge section comprises a first larger surface and a second larger surface and a thickness defined between the first larger surface and the second larger surface.
11. A wind turbine blade according to any of the preceding items, wherein the first larger surface and the second larger surface are part of the pressure side and the suction side of the shell structure of the wind turbine blade and wherein the thickness of the trailing edge section increases from the first trailing edge section end toward the second trailing edge section end.
12. A wind turbine blade according to any of the preceding items, wherein the first larger surface and the second larger surface form part of the first upper surface and the first lower surface of the trailing edge panel and wherein the thickness of the trailing edge section is constant or increasing from the first trailing edge section end toward the second trailing edge section end.
13. A wind turbine blade according to any of the preceding items, wherein the trailing edge panel further comprise a raised platform on the trailing edge section having a constant thickness or tapering from the attachment section toward the first trailing edge section end.
14. A wind turbine blade according to any of the preceding items, wherein the trailing edge panel is made of a fibre-reinforced polymer material, a polymer material or any other suitable material.
15. A wind turbine blade according to any of the preceding items, wherein the plurality of slits further includes a third plurality of slits extending a third distance from the first trailing edge section end toward the second trailing edge section end, wherein the third distance is smaller than the second distance.
16. A wind turbine blade according to any of the preceding items, wherein the plurality of slits further include an Xth plurality of slits, wherein X is between 4-20, wherein each of the Xth plurality of slits extend an Xth distance from the first trailing edge section end towards the second trailing edge section end and wherein the distance from the first trailing edge section end toward the second trailing edge section end decreases the higher the number of X.
17. A wind turbine blade according to any of the preceding items, wherein a slit of the plurality of slits is defined as material removed from the trailing edge section and wherein each slit has a length, a width and a thickness defining a space in the trailing edge section from where material is removed, wherein
   the length of a slit corresponds to the distance the slit extends from the first trailing edge section end toward the second trailing edge section end,
   the width of a slit is defined as the distance each slit extends in a direction perpendicular to the length, and
   the thickness of a slit is defined as the distance between the first larger surface of the trailing edge section and the second larger surface of the trailing edge section.
18. A wind turbine blade according to any of the preceding items, wherein the plurality of slits are straight in the length direction and straight in the thickness direction.
19. A wind turbine blade according to any of the preceding items, wherein areas between adjacent slits at the first trailing edge section end of the trailing edge section are shaped to having tapering portions or serrations.
20. A wind turbine blade according to any of the preceding items, wherein the width of the plurality of slits is constant in an area most proximal to the second trailing edge section end and part of an area most proximal to the first trailing edge section end but increases from the second trailing edge end toward the first trailing edge end in an outermost part of an area most proximal to the first trailing edge section end, such as to form serrations in the trailing edge section between adjacent slits.
21. A wind turbine blade according to any of the preceding items, wherein the amount of material removed from different areas of the trailing edge section, i.e the porosity of the trailing edge section, decreases from the second trailing edge section end toward the first trailing edge section end.
22. A wind turbine blade according to any of the preceding items, wherein the trailing edge section is divided into a plurality of areas comprising different porosities, including the area most proximal to the first trailing edge end and an area most proximal to the second trailing edge section and optionally one or more intermediate areas, wherein the amount of material removed in each area is increasing from the area most proximal to the second trailing edge end toward the area most proximal to the first trailing edge end.
23. A wind turbine blade according to any of the preceding items, wherein the area most proximal to the first trailing edge section may be defined between the first trailing edge section end and a plane extending through the trailing edge section at a predetermined distance from the first trailing edge section end, wherein the predetermined distance corresponds to the length of the plurality of slits with the shortest length.
24. A wind turbine blade according to any of the preceding items, wherein the area most proximal to the second trailing edge section may be defined between the second trailing edge section end and a plane extending through the trailing edge section at a predetermined distance from the second trailing edge section end, wherein the predetermined distance corresponds to the length of the plurality of the first plurality of slits minus the length of the second plurality of slits.
25. A wind turbine blade according to any of the preceding items, wherein the intermediate areas may be defined between the area most proximal to the first trailing edge and the area most proximal to the second trailing edge, based on the amount of material removed.
26. A wind turbine blade according to any of the preceding items, wherein the area most proximal to the first trailing edge section includes the highest number of slits or parts of slits and the area most proximal to the second trailing edge section includes the lowest number of slits or parts of slits.
27. A wind turbine blade according to any of the preceding items, wherein the plurality of slits are arranged equidistantly along the spanwise direction of the trailing edge section.
28. A wind turbine blade according to any of the preceding items, wherein each of the first plurality of slits are arranged between two of the second plurality of slits, such that the first plurality of slits and the second plurality of slits alternate along the trailing edge section.
29. A wind turbine blade according to any of the preceding items, wherein each of the first plurality of slits and each of the second plurality of slits are arranged between two of the third plurality of slits, such as to form a repeating pattern of slits along the trailing edge section, wherein the pattern comprises: one of the third plurality of slits, one of the second plurality of slits, one of the third plurality of slits, one of the first plurality of slits.
30. A wind turbine blade according to any of the preceding items, wherein the ratio between the number of the first plurality of slits and the second plurality of slits is approximately 1:1.
31. A wind turbine blade according to any of the preceding items, wherein the ratio between the number of the second plurality of slits and the third plurality of slits is approximately 1:2.
32. A wind turbine blade according to any of the preceding items, wherein the ratio between the number of the Xth plurality of slits and the number of (X+1)th plurality of slits is approximately 1:2, wherein X is between 3-19.
33. A wind turbine blade according to any of the preceding items, wherein the predetermined distance between the first trailing edge section end and the second trailing edge section end of the trailing edge section is 5-30% of the chord-length of the shell structure of the wind turbine blade.
34. A trailing edge panel configured to be attached at a trailing edge of a shell structure of a wind turbine blade, wherein the trailing edge panel comprises:
   an attachment section configured to be attached to and extend from the trailing edge of the shell structure of the wind turbine blade and to an upstream position on a first blade side of the shell structure of the wind turbine blade,
   a trailing edge section extending from the attachment section and configured to project out from the trailing edge of the shell structure of the wind turbine blade, wherein the trailing edge section is defined between
      a first trailing edge section end, wherein the first trailing edge section end is configured to extend along at least part of the span of the shell structure of the wind turbine blade and is the most distal end of the trailing edge section relative to the attachment section, and
      a second trailing edge section end, wherein the second trailing edge section end is configured to extend along at least part of the span of the shell structure of the wind turbine blade and is a plane going through the trailing edge panel defined at a predetermined distance from the first trailing edge section end toward the attachment section,
and wherein the trailing edge section comprises a plurality of slits, including:
   a first plurality of slits extending a first distance from the first trailing edge section end toward the second trailing edge section end, and
   a second plurality of slits extending a second distance from the first trailing edge section end toward the second trailing edge section end, wherein the second distance is smaller than the first distance.

LIST OF REFERENCE NUMERALS

| | |
|---|---|
| 2 | wind turbine |
| 4 | tower |
| 6 | nacelle |
| 8 | hub |
| 10 | wind turbine blade |
| 11 | suction side |
| 12 | pressure side |
| 14 | tip end |
| 16 | root end |
| 18 | leading edge |
| 20 | trailing edge |
| 30 | root region |
| 32 | transition region |
| 34 | airfoil region |
| 40 | shoulder/position of maximum chord |
| 100 | trailing edge panel |
| 101 | attachment section |
| 102 | trailing edge section |
| 103 | first trailing edge section end |
| 104 | second trailing edge section end |
| 105 | first larger surface of trailing edge section |
| 106 | second larger surface of trailing edge section |
| 107 | area most proximal to the first trailing edge section |
| 108 | area most proximal to the second trailing edge section |
| 109 | intermediate area |
| 110 | first plurality of slits |
| 111 | first distance |
| 112 | width of plurality of slits |
| 113 | thickness of plurality of slits |
| 120 | second plurality of slits |
| 121 | second distance |
| 130 | third plurality of slits |
| 131 | third distance |
| 140 | raised platform of trailing edge section |
| 141 | tapering portions or serrations at the first trailing edge section end |
| 150a | plane extending through the trailing edge section at a predetermined distance from |
| | the first trailing edge section end |
| 150b | plane extending through the trailing edge section at a predetermined distance from |
| | the second trailing edge section end |

1. A wind turbine blade comprising a shell structure having a profiled contour including a pressure side and a suction side and a leading edge and a trailing edge with a chord having a chord length extending therebetween, the shell structure of the wind turbine blade extending in a spanwise direction between a root end and a tip end, wherein the wind turbine blade comprises a trailing edge section defined between a first trailing edge section end and a second trailing edge section end, wherein the trailing edge section comprises a plurality of slits, including:
a first plurality of slits extending a first distance from the first trailing edge section end toward the second trailing edge section end, and
a second plurality of slits extending a second distance from the first trailing edge section end toward the second trailing edge section end, wherein the second distance is smaller than the first distance, and
wherein the trailing edge section is part of the shell structure of the wind turbine blade or wherein the trailing edge section is part of a trailing edge panel attached to the shell structure of the wind turbine blade.

2. A wind turbine blade according to claim 1, wherein the trailing edge section is part of the shell structure of the wind turbine blade and the first trailing edge section end corresponds to the trailing edge of the shell structure of the wind turbine blade and the second trailing edge section end extends along at least part of the span of the shell structure of the wind turbine blade and is a plane going through the shell structure of the wind turbine blade defined at a predetermined distance from the first trailing edge section end toward the leading edge of the shell structure of the wind turbine blade.

3. A wind turbine blade according to claim 1, wherein the trailing edge section is part of a trailing edge panel attached to the shell structure of the wind turbine blade, wherein the trailing edge panel comprises:
an attachment section being attached to the trailing edge of the shell structure of the wind turbine blade,
the trailing edge section extending from the attachment section and projecting out from the trailing edge of the shell structure of the wind turbine blade, wherein
the first trailing edge section end extends along at least part of the span of the shell structure of the wind turbine blade and is the most distal end of the trailing edge section relative to the attachment section, and
the second trailing edge section end extends along at least part of the span of the shell structure of the wind turbine blade and is a plane going through the trailing edge panel defined at a predetermined distance from the first trailing edge section end toward the attachment section.

4. A wind turbine blade according to claim 1, wherein the trailing edge panel is made of a fibre-reinforced polymer material, a polymer material, or any other suitable material.

5. A wind turbine blade according to claim 1, wherein the plurality of slits further includes a third plurality of slits extending a third distance from the first trailing edge section end toward the second trailing edge section end, wherein the third distance is smaller than the second distance.

6. A wind turbine blade according to claim 1, wherein a slit of the plurality of slits is defined as material removed from the trailing edge section and wherein each slit has a length, a width and a thickness defining a space in the trailing edge section from where material is removed, wherein
the length of a slit corresponds to the distance the slit extends from the first trailing edge section end toward the second trailing edge section end,
the width of a slit is defined as the distance each slit extends in a direction perpendicular to the length, and
the thickness of a slit is defined as the distance between a first larger surface of the trailing edge section and a second larger surface of the trailing edge section.

7. A wind turbine blade according to claim 1, wherein the plurality of slits are straight in the length direction and straight in the thickness direction.

8. A wind turbine blade according to claim 1, wherein areas between adjacent slits at the first trailing edge section end of the trailing edge section are shaped to having tapering portions or serrations.

9. A wind turbine blade according to claim 1, wherein the amount of material removed from different areas of the trailing edge section decreases from the second trailing edge section end toward the first trailing edge section end.

10. A wind turbine blade according to claim 1, wherein the trailing edge section is divided into a plurality of areas comprising different porosities, including an area most proximal to the first trailing edge end and an area most proximal to the second trailing edge section and optionally one or more intermediate areas, wherein the amount of material removed in each area is increasing from the area most proximal to the second trailing edge end toward the area most proximal to the first trailing edge end.

11. A wind turbine blade according to claim 1, wherein the area most proximal to the first trailing edge section includes the highest number of slits or parts of slits and the area most proximal to the second trailing edge section includes the lowest number of slits or parts of slits.

12. A wind turbine blade according to claim 1, wherein the plurality of slits are arranged equidistantly along the spanwise direction the trailing edge section.

13. A wind turbine blade according to claim 1, wherein each of the first plurality of slits are arranged between two of the second plurality of slits, such that the first plurality of slits and the second plurality of slits alternate along the trailing edge section.

14. A wind turbine blade according to claim 1, wherein the ratio between the number of the first plurality of slits and the second plurality of slits is approximately 1:1.

15. A trailing edge panel configured to be attached at a trailing edge of a shell structure of a wind turbine blade, wherein the trailing edge panel comprises:
an attachment section configured to be attached to and extend from the trailing edge of the shell structure of the wind turbine blade and to an upstream position on a first blade side of the shell structure of the wind turbine blade,
a trailing edge section extending from the attachment section and configured to project out from the trailing edge of the shell structure of the wind turbine blade, wherein the trailing edge section is defined between
a first trailing edge section end, wherein the first trailing edge section end is configured to extend along at least part of the span of the shell structure of the wind turbine blade and is the most distal end of the trailing edge section relative to the attachment section, and
a second trailing edge section end, wherein the second trailing edge section end is configured to extend along at least part of the span of the shell structure of the wind turbine blade and is a plane going through the trailing edge panel defined at a predetermined distance from the first trailing edge section end toward the attachment section,
and wherein the trailing edge section comprises a plurality of slits, including:
a first plurality of slits extending a first distance from the first trailing edge section end toward the second trailing edge section end, and
a second plurality of slits extending a second distance from the first trailing edge section end toward the second trailing edge section end, wherein the second distance is smaller than the first distance.
